(19) United States
(12) Patent Application Publication
(10) Pub. No.: US 2015/0155572 A1
(43) Pub. Date: Jun. 4, 2015

(54) FLEXIBLE FUEL CELL AND METHOD OF MANUFACTURING THE SAME

(71) Applicant: SNU R&DB Foundation, Seoul (KR)

(72) Inventors: Ik Whang Chang, Daegu (KR); Tae Hyun Park, Seoul (KR); Yoon Ho Lee, Seoul (KR); Suk Won Cha, Seoul (KR)

(73) Assignee: SNU R&DB FOUNDATION

(21) Appl. No.: 14/615,710

(22) Filed: Feb. 6, 2015

Related U.S. Application Data
(62) Division of application No. 13/776,270, filed on Feb. 25, 2013.

(30) Foreign Application Priority Data
Mar. 29, 2012 (KR) 10-2012-0032609

(51) Int. Cl. H01M 8/02; H01M 8/10

(52) U.S. Cl. CPC H01M 8/0297; H01M 8/10

(57) ABSTRACT

Disclosed herein is a flexible fuel cell, including: (i) an anode comprising an anode end plate structure made of a polymer material and provided with a hydrogen flow channel and a collector made of a metal layer deposited on the anode end plate structure; (ii) a cathode comprising a cathode end plate structure made of a polymer material and provided with an air flow channel having air holes and a collector formed of a metal layer deposited on the cathode end plate structure; and (iii) a membrane electrode assembly (MEA) comprising a polymer electrolyte membrane whose surface is coated with a catalyst layer and a gas diffusion layer (GDL) provided on at least one side thereof, wherein the membrane electrode assembly is interposed and pressed between the anode and the cathode.

### CROSS-REFERENCE TO RELATED APPLICATIONS

This application is a divisional application of U.S. application Ser. No. 13/776,270 filed on Feb. 25, 2013, which claims priority to Korean Application No. 10-2012-0032609 filed on Mar. 29, 2012. The applications are incorporated herein by reference.

### BACKGROUND

1. Technical Field

The present invention relates to a flexible fuel cell and a method of manufacturing the same, and, more particularly, to a flexible fuel cell, in which an anode end plate and cathode end plate made of a material having high flexibility are deposited with a metal film to be used as a collector, and a method of manufacturing the same.

2. Description of the Related Art

Among various renewable energy devices, fuel cells are regarded as the most promising direct energy conversion devices for producing electric energy because they have a low carbon emission rate and high energy efficiency. Particularly, polymer electrolyte fuel cells (PEFCs) are known to have the highest power density and durability. Moreover, PEFCs can be suitably used for mobile appliances or portable appliances because they can be operated at low temperature. In order for PEFCs to be used for mobile appliances or portable appliances, they must have a simple system, must easily conduct fuel exchange and must exhibit stable performance regardless of peripheral conditions.

Recently, the demand for flexible appliances used for various purposes, including energy devices, has been rapidly increasing. Further, flexible materials, such as polymers, metal foil, etc., have gradually attracted considerable attention in the field of flexible displays and electronic sensors. The meanings of flexibility can be classified into three categories, that is, whether a target system can be bent to some degree, whether a target system has a permanent form and whether a target system can be softly extended. Among such meanings, research into flexible electronic appliances is generally related to whether a target system can be bent to some degree and whether a target system can be extended to some degree.

Research into flexible electronic appliances, which are made based on polydimethylsiloxane (PDMS) of flexible materials such as glass, plastic film and metal foil, has been widely conducted. Research into biocompatible electronic appliances and optical electronic appliances based on flexible materials was reported (D.-H. Kim, J. A. Rodgers, Adv. Mater. 20 (2008) 4887.; G. Shin, I. Jung, V. Malyarchuk, J. Song, S. Wang, H. C. Ko, Y. Huang, J. S. Ha, J. A. Rogers, Small 6 (2010) 851.). Further, It was reported that the peak power density of a H₂-O₂ flexible fuel cell having an active area of 10˜100 mm² is 57 mW/cm² (J. Wheldon, W. J. Lee, D. H. Lee, A. B. Broste, M. Bollinger, W. H. Smyrl, Electrochem. SolidSt. 12 (2009) B86.). However, this research proposed a simple laminate structure including unit cells using organic matter and gold-plated copper meshes.

### SUMMARY

Accordingly, the present invention has been devised to solve the above-mentioned problems, and an object of the present invention is to provide a flexible fuel cell, in which an anode end plate and cathode end plate made of a material having high flexibility are deposited with a metal film to be a collector.

Another object of the present invention is to provide a method of manufacturing the flexible fuel cell.

In order to accomplish the above objects, an aspect of the present invention provides a flexible fuel cell, including: (i) an anode comprising an anode end plate structure made of a polymer material and provided with a hydrogen flow channel and a collector made of a metal layer deposited on the anode end plate structure; (ii) a cathode comprising a cathode end plate structure made of a polymer material and provided with an air flow channel having air holes and a collector formed of a metal layer deposited on the cathode end plate structure; and (iii) a membrane electrode assembly (MEA) comprising a polymer electrolyte membrane whose surface is coated with a catalyst layer and a gas diffusion layer (GDL) provided on at least one side thereof, wherein the membrane electrode assembly is interposed and pressed between the anode and the cathode.

Here, the polymer material may be selected from the group consisting of polymethyl methacrylate, poly(vinylchloride), polycarbonate, polystyrene, poly(dimethylsiloxane), polyurethane, polystyrene, polybutadiene, and mixtures thereof.

The collector may be formed by sequentially depositing a first metal layer and a second metal layer on the polymer structure by sputtering, and each of the first metal layer and the second metal layer may be made of any metal selected from the group consisting of Ni, Au, Ag, Pt, Cr, Fe, Mn, Cu, Al, Ti, La, Mg, Mo, Zn, Pb, Sn, C, and W, or an oxide thereof.

The thickness of the first metal layer may be 10˜5000 nm, and the thickness of the second metal layer may be 10˜5000 nm.

The collector may be formed of a metal mesh having a size of 10˜250 meshes, and the metal mesh may be made of at least one selected from the group consisting of Ni, Au, Ag, Pt, Cr, Fe, Mn, Cu, Al, Ti, La, Mg, Mo, Zn, Pb, Sn, C, and W, or an oxide thereof.

The collector may be formed of a metal foil, and the metal foil may be made of at least one selected from the group consisting of Ni, Au, Ag, Pt, Cr, Fe, Mn, Cu, Al, Ti, La, Mg, Mo, Zn, Pb, Sn, C, and W, or an oxide thereof.

When the membrane electrode assembly is disposed and pressed between the anode and the cathode, the membrane electrode assembly may be pressed while ends of the membrane electrode assembly, the anode and the cathode are bent to apply tensile stress or compressive stress to the ends thereof.

Another aspect of the present invention provides a method of manufacturing a flexible fuel cell, including the steps of: (a) coating a stainless steel substrate serving as a mold with a polymer material and then detaching the substrate from the polymer material using a lift-off process to form an anode end plate structure and a cathode end plate structure; (b) sequentially depositing a first metal layer and a second metal layer on each of the anode end plate structure and the cathode end plate structure using sputtering, thermal evaporation, chemical vapor deposition or electroless plating; and (c) interposing a membrane electrode assembly between the anode end plate structure and the cathode end plate structure and pressing them.

In the step (a), the anode end plate structure and the cathode end plate structure may be formed by using injection molding or extrusion molding instead of the lift-off process.

In the step (a), each of the anode end plate structure and the cathode end plate structure may be formed such that the anode end plate structure provided with a hydrogen flow channel and the cathode end plate structure is provided with a rectangular air flow channel having air holes, the air flow channel corresponding to the hydrogen flow channel.

The method may further include the step of ultrasonically treating each of the anode end plate structure and the cathode end plate structure in ethanol solution and then surface-treating it with sandpaper, before the step (b).

The polymer material may be selected from the group consisting of polymethyl methacrylate, poly(vinylchloride), polycarbonate, polystyrene, poly(dimethylsiloxane), polyurethane, polystyrene, polybutadiene, and mixtures thereof.

Each of the first metal layer and the second metal layer may be made of any one selected from the group consisting of Ni, Au, Ag, Pt, Cr, Fe, Mn, Cu, Al, Ti, La, Mg, Mo, Zn, Pb, Sn, C, and W, or an oxide thereof.

The membrane electrode assembly (MEA) may include a polymer electrolyte membrane whose surface is coated with a catalyst layer and a gas diffusion layer (GDL) provided on at least one side thereof.

In the step (c), the membrane electrode assembly may be pressed while ends of the membrane electrode assembly, the anode and the cathode are bent to apply tensile stress or compressive stress to the ends thereof.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a process view showing a method of manufacturing a flexible fuel cell according to an embodiment of the present invention;

FIG. 2A is a graph showing the results of I-V characteristics of a flexible fuel cell including a gas diffusion layer (GDL) or not including the same according to the present invention;

FIG. 2B is a graph showing the results of ohm resistance values of a flexible fuel cell including a gas diffusion layer (GDL) or not including the same according to the present invention;

FIG. 3A is a photograph showing a flexible fuel cell that was not bent by a table vice, and FIG. 3B is a photograph showing a flexible fuel cell that was bent by a table vice;

FIGS. 4A is a SEM photograph showing the section of a collector including a PDMS substrate, a nickel (Ni) layer and a gold (Au) layer according to an embodiment of the present invention, FIGS. 4B is a SEM photograph showing the surface of the collector, and FIG. 4C is a photograph showing a fuel cell manufactured according to an embodiment of the present invention; and

FIG. 5A is a schematic view showing the shape of a fuel cell including an anode, a cathode and a membrane electrode assembly under the condition that stress was not applied, FIG. 5B is a schematic view showing the shape of the fuel cell under the condition that compressive stress was applied, and FIG. 5C is a schematic view showing the shape of the fuel cell under the condition that tensile stress was applied.

### DETAILED DESCRIPTION

Hereinafter, embodiments of the present invention will be described in detail with reference to the attached drawings.

The polymer-based flexible fuel cell according to the present invention is characterized in that a polymer material, particularly, polydimethylsiloxane (PDMS) is used as a raw material of an end plate, and a metal film is deposited on the patterned PDMS by sputtering to be used as a collector, so this fuel cell can be bent without deteriorating the performance thereof under a bending condition.

A flexible fuel cell largely includes three components, that is, a membrane electrode assembly (MEA), an anode and cathode each having a collector, and end plates for the anode and cathode.

The present invention provides a flexible fuel cell, including: (i) an anode comprising an anode end plate structure made of a polymer material and provided with a hydrogen flow channel and a collector made of a metal layer deposited on the anode end plate structure; (ii) a cathode comprising a cathode end plate structure made of a polymer material and provided with an air flow channel having air holes and a collector formed of a metal layer deposited on the cathode end plate structure; and (iii) a membrane electrode assembly (MEA) comprising a polymer electrolyte membrane whose surface is coated with a catalyst layer and a gas diffusion layer (GDL) provided on at least one side thereof.

Here, the polymer material may be a thermosetting polymer or a thermoplastic polymer. Specifically, the polymer material may be selected from the group consisting of polymethylmethacrylate, poly(vinylchloride), polycarbonate, polystyrene, poly(dimethylsiloxane), polyurethane, polystyrene, polybutadiene, and mixtures thereof. Preferably, the polymer material may be polydimethylsiloxane.

PDMS has high flexibility (360-870 KPa) because it is a silicon elastomer having a low elastic modulus (Young's modulus). Therefore, the flexibility of PDMS is very excellent compared to that of a material constituting an end plate, for example, polycarbonate (2.4 GPa), graphite (10 GPa) or stainless steel (190 GPa), thus enabling a flexible fuel cell to be realized.

The collector is formed of a metal layer directly deposited on an end plate structure in the form of a thin film. Preferably, the collector may be formed by sequentially depositing a first metal layer and a second metal layer on the end plate structure by sputtering. Each of the first metal layer and the second metal layer may be made of any metal selected from the group consisting of Ni, Au, Ag, Pt, Cr, Fe, Mn, Cu, Al, Ti, La, Mg, Mo, Zn, Pb, Sn, C, and W, or an oxide thereof. Preferably, the first metal may be made of Ni, and the second metal layer may be made of Au.

Further, the metal layer may be a metal foil or a metal mesh, not a thin film formed by sputtering. When the metal layer is a metal mesh, the metal mesh must have a mesh size of 10˜250 in which oxygen is diffused by the metal mesh to reach a cathode. When the mesh size thereof is more than 250, oxygen gas has difficulty penetrating the metal mesh, thus deteriorating the performance of a fuel cell. Therefore, it is preferred that the mesh size thereof be 10˜250.

The membrane electrode assembly is characterized in that, when the membrane electrode assembly is disposed and pressed between the anode and the cathode, the membrane electrode assembly is pressed while ends of the membrane electrode assembly, the anode and the cathode are bent to apply tensile stress or compressive stress to the ends thereof.

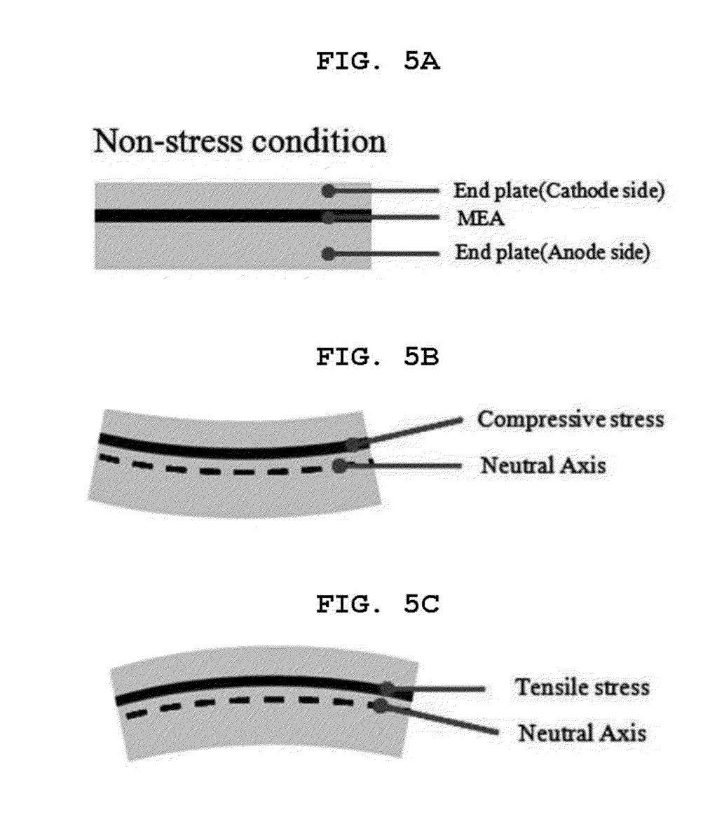

FIG. 5A to 5C show the states of stress not being applied (FIG. 5A), compressive stress being applied (FIG. 5B) and tensile stress being applied (FIG. 5C), respectively. That is, when an anode end plate, a membrane electrode assembly and a cathode end plate are pressed and assembled into a flexible fuel cell in a state in which they are bent (they are not flat), pressure is uniformly applied to the center and ends of the flexible fuel cell under the condition of the fuel cell being bent, so the ends of the fuel cell, which are spaced far apart from the center of the fuel cell, can also be brought into electric contact with external terminals, thereby allowing the flexible fuel cell to exhibit excellent performance.

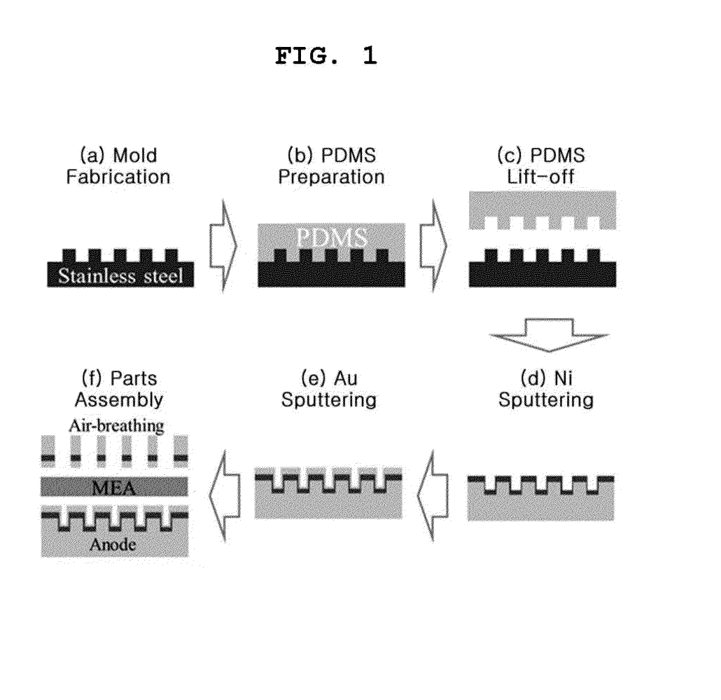

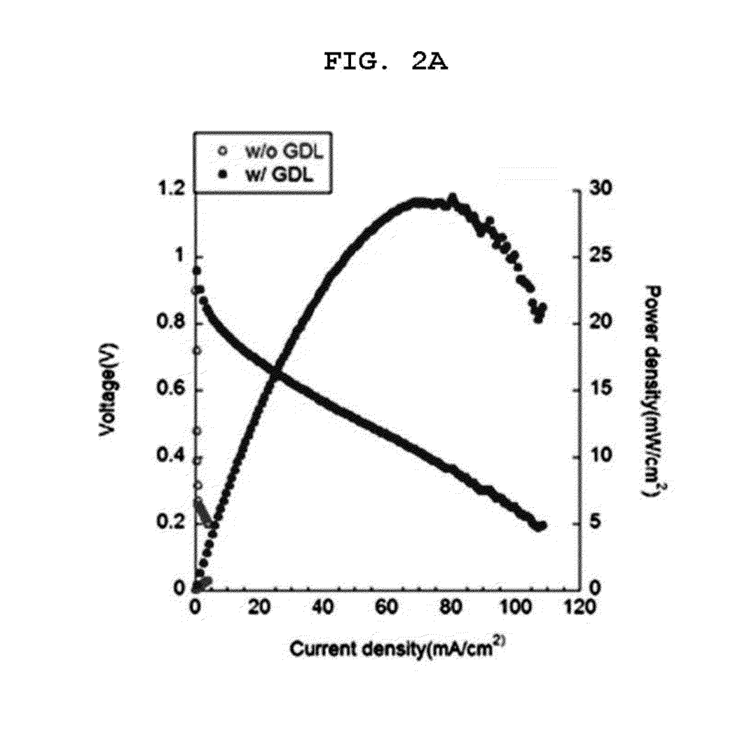

FIG. 1 is a process view showing a method of manufacturing a flexible fuel cell according to the present invention.

The method of manufacturing a flexible fuel cell according to the present invention includes the steps of: (a) coating a stainless steel substrate serving as a mold with a polymer material and then detaching the substrate from the polymer material using a lift-off process to form an anode end plate structure and a cathode end plate structure; (b) sequentially depositing a first metal layer and a second metal layer on each of the anode end plate structure and the cathode end plate structure using sputtering, thermal evaporation, chemical vapor deposition or electroless plating; and (c) interposing a membrane electrode assembly between the anode end plate structure and the cathode end plate structure and pressing them.

Hereinafter, the present invention will be described in more detail with reference to the following Examples. However, these Examples are set forth to illustrate the present invention, and the scope of the present invention is not limited thereto. It will be obvious that the present invention can be changed and modified within the scope and technical idea thereof by those skilled in the art.

### EXAMPLE

Manufacture of a Flexible Fuel Cell According to the Present Invention

(1) A stainless steel mold for forming an anode end plate structure including a hydrogen flow channel having a width of 1 mm, a depth (or height) of 1 mm and a length of 30 mm was provided, and a stainless steel mold for forming a cathode end plate structure including a rectangular air flow channel having a width of 2.5 mm, a depth of 6 mm and a length of 28 mm was provided.

A cathode is exposed to the air without using an air injecting and compressing system (that is, this cathode is an air-breathing cathode), and an oxygen reduction reaction occurring in the cathode is generally known to cause a severe loss, so the opening rate of the cathode is set higher. However, the opening rate thereof can be increased without limitation because of the problem of structural stability, and the clamping force transferred to MEA must be considered. Therefore, in embodiments of the present invention, the opening rate thereof was set to less than 50% (specifically, 38%).

(2) Polydimethylsiloxane (PDMS) and a curing agent were mixed at a mixing ratio of 10:1, and then heated to 70° C. for 4 hours.

(3) Each of the provided stainless steel molds was coated with polydimethylsiloxane (PDMS), and then a lift-off process was carried out to obtain an anode end plate structure having a size of 4 cm×4 cm and a cathode end plate structure having a size of 4 cm×4 cm.

(4) Each of the PDMS structures was ultrasonically treated for 5 minutes, surface-treated with sandpaper to improve the adhesivity of a metal layer to the PDMS structure, and then deposited with a thin metal layer functioning as a collector by DC sputtering. During the sputtering, the distance between a target and a substrate was 6 cm, and the deposition power was 200 W under a pressure of 5 mtorr Ar.

First, a nickel (Ni) layer having a thickness of 880 nm was deposited on each of the PDMS structures for 5 minutes. Subsequently, a gold (Au) layer having a thickness of 3.8 μm was deposited on the nickel (Ni) layer for 20 minutes under the same condition as in the deposition of nickel (Ni) layer.

(5) The PDMS structures, each of which was deposited with the collector, and a membrane electrode assembly (MEA) were pressed and attached to form a three-layer structure including an anode coated with Ni and Au, a cathode coated Ni and Au and a membrane electrode assembly (MEA).

Two types of MEAs were used as the membrane electrode assembly (MEA). The first type of MEA (CNL, Korea) is commercially available, and is a polymer membrane (Nafion 212, DuPont) loaded with a platinum (Pt) catalyst in an amount of 0.4 mg/cm². Further, the first type of MEA was provided on both sides thereof with gas diffusion layers (GDLs). SGL 10BC (SGL, USA) having a thickness of 420 pm was used as the gas diffusion layer. The second type of MEA was not provided with gas diffusion layers. That is, a MEA, which was not provided with gas diffusion layers and was coated with a pure catalyst, was used as the second type of MEA.

The test parameters of the two types of MEAs (including GDL and not including GDL) were identical to each other, and the active area of each of the MEAs was 3 cm×3 cm.

### TEST EXAMPLE

(1) Current-voltage (I-V) and electrochemical impedance spectroscopy (EIS) were measured using a combination of Solartrons 1287 and 1260. Current-voltage (I-V) was 3 mA/sec in a galvano-dynamic mode, and EIS measurement was performed using an AC impedance of 30 mV under a predetermined bias voltage of 0.3 V. Humidified hydrogen (H₂) of 20° C. was supplied to an anode at a flow rate of 50 sccm, and a cathode was exposed to the air (air-breathing cathode).

Test was conducted in order of 1) supplying hydrogen (H₂), 2) measuring OCV for 10 minutes, 3) measuring galvanostatic electricity in a current of 0.1, 0.3 and 0.5 A for 10 minutes with respect to each humidified membrane and catalyst layer.

(2) The scanning electron microscope images of the sections of PDMS end plates were obtained using focused ion beam (Quanta 3D FEG, manufactured by FEI Inc., in Netherland).

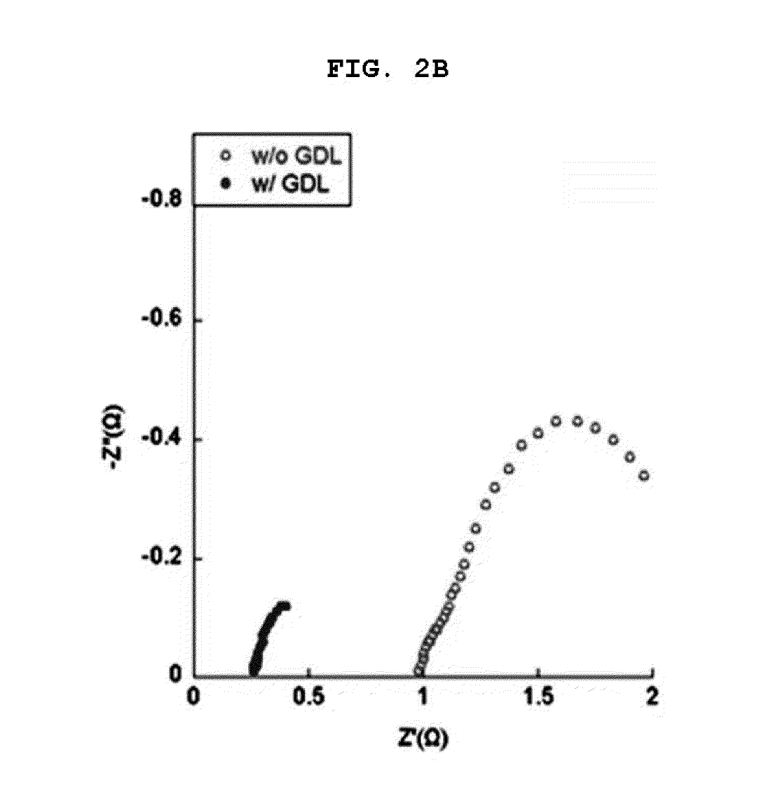

(3) FIG. 2A shows the I-V characteristics of fuel cells including GDL or not including GDL. As shown in FIG. 2A, it can be seen that fuel cells including GDL exhibit excellent I-V characteristics compared to fuel cells not including GDL. Further, it can be seen that the OCV of fuel cells including GDL approaches 1 V, but that of fuel cells not including GDL does not reach 0.9 V.

FIG. 2B shows that the ohm resistance value (about 1 ohm at the highest frequency) of fuel cells not including GDL is about 4 times greater than that (about 0.25 ohm at the highest frequency) of fuel cells including GDL. Moreover, FIG. 2B shows that the kinetic loss of fuel cells not including GDL is greater than that of fuel cells including GDL. It is determined that the results shown in FIG. 2B are due to the fact that the fuel cells not including GDL have rough Au surface and low clamping force and thus have poor adhesiveness to gas. Further, it is determined that GDL serves as a gap-filler and serves as a buffer for uniformly distributing mechanical pressure.

(4) The area of the initial end plate used to assemble a fuel cell was about 45 mm², but was decreased to about 40 mm² when it was pressed. In the case of a bent fuel cell, the strain (e) of the end plate, the strain (e) being defined as a reduction ratio of a length to the initial length measured along the center line of the end plate, was 11%.

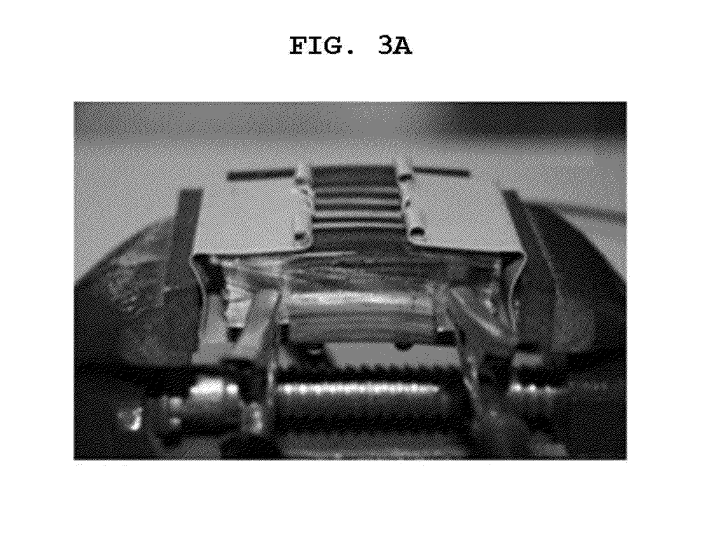

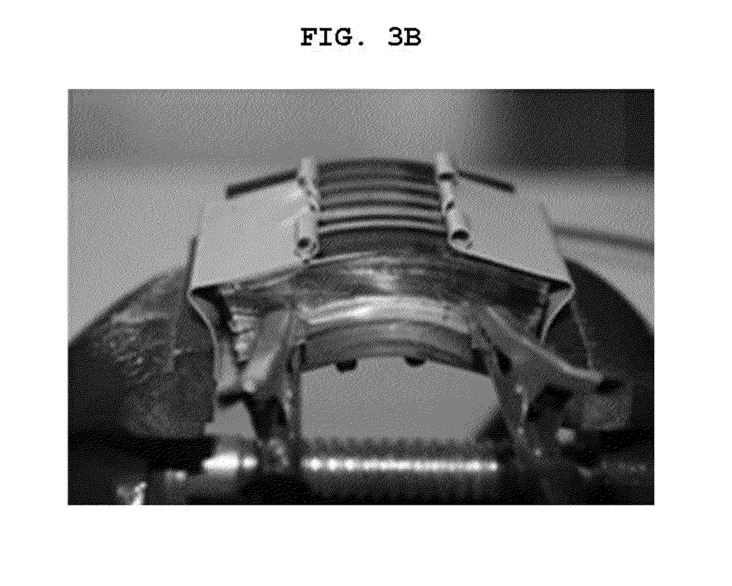

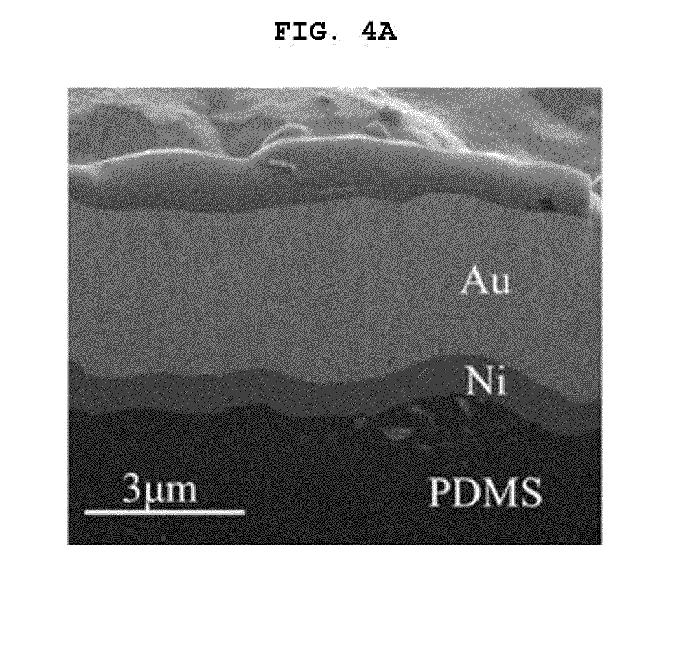

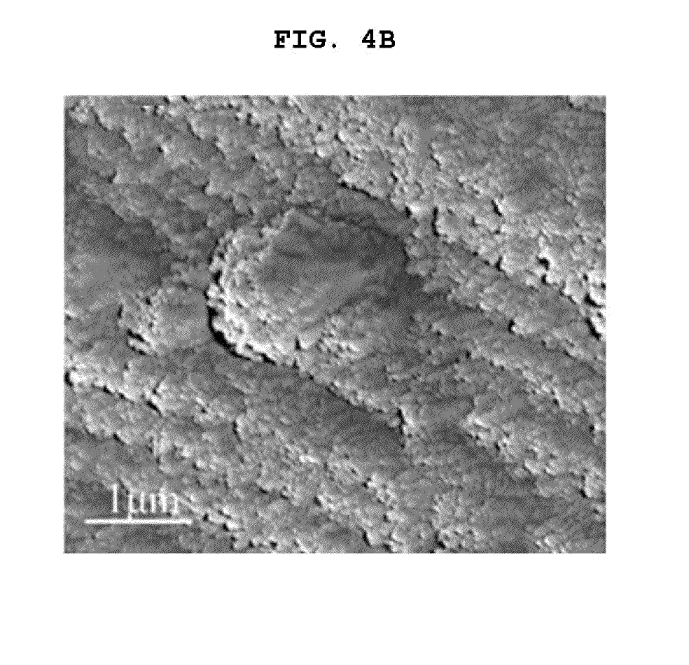

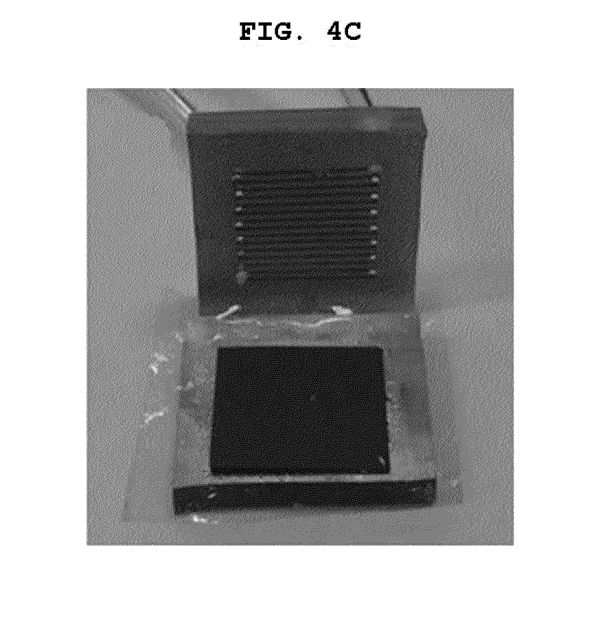

(5) According to the results of I-V characteristics of a flexible fuel cell (shown in FIG. 3A) that was not bent and a flexible fuel cell (shown in FIG. 3B) that was bent by a table vice, it can be seen that the powder density of the flexible fuel cell (shown in FIG. 3A) was 29.1 mW/cm², the powder density of the flexible fuel cell (shown in FIG. 3B) was 20.5 mW/cm², and these results were similar to those obtained under a condition of OCV (˜1.0 V). Therefore, it can be ascertained that the electric contact between components of the fuel cell of the present invention was not deteriorated even when the fuel cell was bent. Meanwhile, even from the impedance results, it can also be ascertained that the degree of activation of the flexible fuel cell (shown in FIG. 3A) according to potential is similar to that of the flexible fuel cell (shown in FIG. 3B).

Consequently, from the results of I-V and ELS, it can be ascertained that the difference in powder density is caused by the difference in ohm loss. That is, it is determined that the reason why ohm loss increases when the fuel cell is bent is caused by the rigidity of GDL and the possibility of a Ni/Au film being separated from a thin film layer.

That is, when the fuel cell is bent, pressure is not uniformly applied to the fuel cell because of the rigidity of GDL, and thus the ends of the fuel, each of which is spaced far apart form the center of the fuel, are not easily brought into electric contact with external terminals. Further, the possibility of a Ni/Au film being separated from a thin film layer during a process of bending the fuel cell exerts a bad influence on ohm resistance.

In order to minimize the above problem, the present invention is characterized in that an anode end plate, a membrane electrode assembly and a cathode end plate are pressed and assembled into a flexible fuel cell in a state in which they are bent by the application of tensile stress or compressive stress.

As described above, the flexible fuel cell according to the present invention is characterized in that end plates are made of a flexible material, collectors are directly deposited on the end plates to form anode and cathode, and the cathode and anode are attached to both sides of a membrane electrode assembly by pressing, thus manufacturing the fuel cell. Therefore, the flexible fuel cell manufactured in this way can be applied in various fields because it has excellent flexibility. Further, this flexible fuel cell exhibit high stability, durability and efficiency because the electric contact between layers of the fuel cell is not deteriorated even when tensile stress or compressive stress is applied to the fuel cell.

Although the embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method of manufacturing a flexible fuel cell, comprising the steps of:
(a) coating a stainless steel substrate serving as a mold with a polymer material and then detaching the substrate from the polymer material using a lift-off process to form an anode end plate structure and a cathode end plate structure;
(b) sequentially depositing a first metal layer and a second metal layer on each of the anode end plate structure and the cathode end plate structure using sputtering, thermal evaporation, chemical vapor deposition or electroless plating; and
(c) interposing a membrane electrode assembly between the anode end plate structure and the cathode end plate structure and pressing them.

2. The method of claim 1, wherein, in the step (a), the anode end plate structure and the cathode end plate structure are formed by using injection molding or extrusion molding instead of the lift-off process.

3. The method of claim 1, wherein, in the step (a), each of the anode end plate structure and the cathode end plate structure are formed such that the anode end plate structure provided with a hydrogen flow channel and the cathode end plate structure is provided with a rectangular air flow channel having air holes, the air flow channel corresponding to the hydrogen flow channel.

4. The method of claim 1, further comprising the step of ultrasonically treating each of the anode end plate structure and the cathode end plate structure in ethanol solution and then surface-treating it with sandpaper, before the step (b).

5. The method of claim 1, wherein the polymer material is selected from the group consisting of polymethyl methacrylate, poly(vinylchloride), polycarbonate, polystyrene, poly(dimethylsiloxane), polyurethane, polystyrene, polybutadiene, and mixtures thereof.

6. The method of claim 1, wherein each of the first metal layer and the second metal layer is made of any metal selected from the group consisting of Ni, Au, Ag, Pt, Cr, Fe, Mn, Cu, Al, Ti, La, Mg, Mo, Zn, Pb, Sn, C, and W, or an oxide thereof.

7. The method of claim 1, wherein the membrane electrode assembly (MEA) comprises a polymer electrolyte membrane whose surface is coated with a catalyst layer and a gas diffusion layer (GDL) provided on at least one side thereof.

8. The method of claim 1, wherein, in the step (c), the membrane electrode assembly is pressed while ends of the membrane electrode assembly, the anode and the cathode are bent to apply tensile stress or compressive stress to the ends thereof.
